(19) United States
(12) Patent Application Publication
(10) Pub. No.: US 2010/0071782 A1
(43) Pub. Date: Mar. 25, 2010

(54) RETAINER FOR COMPONENT CONNECTORS

(76) Inventor: Gary Scheffel, Streetsboro, OH (US)

Correspondence Address: CALFEE HALTER & GRISWOLD, LLP, 800 SUPERIOR AVENUE, SUITE 1400, CLEVELAND, OH, 44114, US

(21) Appl. No.: 12/521,894

(22) PCT Filed: Jan. 10, 2008
(86) PCT No.: PCT/US08/50718

§ 371 Date: Jul. 1, 2009

Related U.S. Application Data
(60) Provisional application No. 60/884,485, filed on Jan. 11, 2007.

(51) Int. Cl. F17D 1/00; F16B 39/32

(52) U.S. Cl. 137/342; 411/327; 137/561 R

(57) ABSTRACT

One or both of two components that are joinable by a connector (22) is provided with a connector retainer mechanism (200) that holds the connector with the component prior to assembly. In one embodiment, a component having a mounting hole (102) therein includes a retainer (202, 204) or holder that keeps a connector in the mounting hole so that the component may be assembled to another component without the connector falling out of the mounting hole prior to such assembly. An example of a connector retainer mechanism is a ball that partially extends into the mounting hole from a transverse bore (208).

### CROSS-REFERENCE TO RELATED APPLICATION

This application claims the benefit of U.S. provisional patent application Ser. No. 60/884,485, entitled RETAINER FOR COMPONENT CONNECTORS and filed Jan. 11, 2007, the entire disclosure of which is fully incorporated herein by reference.

### BACKGROUND OF THE DISCLOSURE

The present disclosure relates to modular flow systems of the type that have surface mounted components installed on a planar support using bolts, screws or other threaded or non-threaded connectors. Such systems, for example but not by way of limitation, are illustrated in the following U.S. Pat. Nos. 6,776,193 and 6,938,644 (the '193 and '644 patents herein), the entire disclosures of which are fully incorporated herein by reference. More broadly, the present disclosure relates to methods and apparatus for providing connections between two bodies or components using threaded or non-threaded connectors in mounting holes.

### SUMMARY OF THE DISCLOSURE

In accordance with an inventive aspect of the disclosure, one or both of two components that are joinable by a connector is provided with a connector retainer mechanism that holds the connector with the component prior to assembly. In one embodiment, a component having a mounting hole therein includes a retainer or holder that keeps a connector in the mounting hole so that the component may be assembled to another component without the connector falling out of the mounting hole prior to such assembly. In a more specific embodiment, a connector may be realized in the form of a threaded bolt or screw that is used to join a surface mount component to a mounting surface such as a substrate. Various embodiments of a connector retainer mechanism are disclosed herein. Optionally, the connector retainer mechanism may releasably retain a connector with the component so that the connector may be removed when such action is so needed such as for repair, maintenance, shipping and so on.

### DESCRIPTION OF THE EXEMPLARY EMBODIMENTS

Although the various embodiments are described herein with specific reference to a modular design such as are shown in the '193 and '644 patents, such description is exemplary in nature and should not be construed in a limiting sense. The various inventive aspects (such as various alternatives of the connector retainer) described herein may be used alone or in various combinations and sub-combinations with other designs and applications, wherein two components may be joined by a connector with one or both of the components having a bore or mounting hole with which a connector is to be retained, and optionally releasably retained in the hole.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

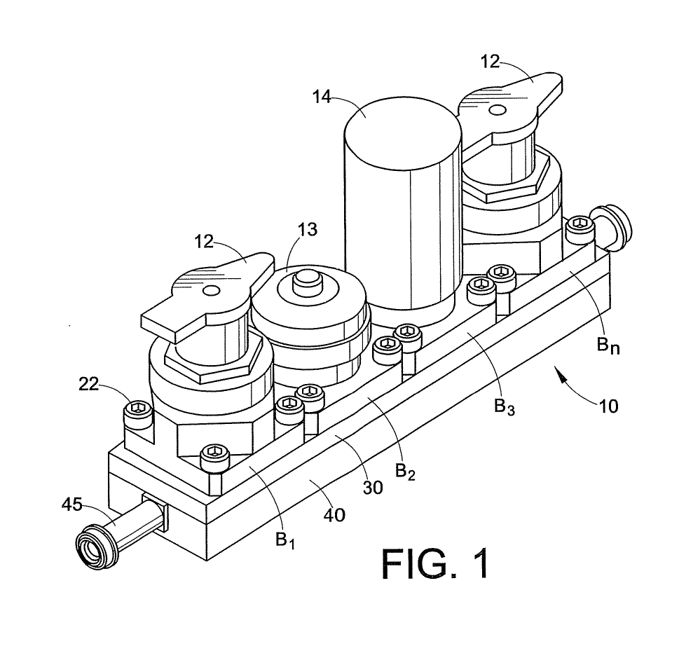

FIG. 1 is a copy of FIG. 1 of the above referenced '193 patent, and is provided as an exemplary illustration of one type of many uses of the inventive concepts disclosed herein. FIG. 1 illustrates a typical modular flow system 10 of the kind that utilizes one or more fluid flow devices 12, 13 14 that are commonly referred to as surface mounted. In the example of FIG. 1, the fluid flow devices 12, 13 and 14 may comprise for example valves, regulators, flow controllers, transducers and so on. Each of the n (n being an integer with n≧1 surface mount devices may include a component, in this case in the exemplary form of a base Bₙ, that is securely mounted to another component, such as a support surface, in this case a plate 30. The base piece may be integral with its associated flow device or separate from and attachable thereto. The first component, such as the base Bₙ, may be fixed to the second component such as the plate 30 by one or more connectors, such as, for example, threaded bolts 22. Each bolt 22 at least partially extends into or through a respective mounting hole in the base Bₙ, and are screwed into a threaded hole in the plate 30. As an alternative, in some modular systems, the plate 30 may be omitted and the surface mount fluid flow devices are installed onto a substrate 40 (FIG. 1) surface or other planar surface. In some systems, the substrate 40 may be a manifold type structure comprising a single piece body or multiple blocks joined together.

Although the present disclosure includes exemplary embodiments for a modular flow system, and specifically shows threaded connectors, those skilled in the art will readily appreciate that the various inventions herein may be incorporated into many different and widely varied uses wherein two components are to be joined together by one or more connectors. Thus the term ‘component’ is to be broadly construed to include any structure that is to be joined to another structure by a connector, wherein the term ‘connector’ may include any device having a body, such as a shank for example, that is to be at least partially received and retained in a bore or hole in the component. Thus, a connector need not be in the form of a bolt, but may be a screw, pin or other mechanical member that joins two components together, whether by a threaded connection or non-threaded connection. An example of a non-threaded connection may be by a press fit or adhesive, for example. The term ‘mounting hole’ is also to be broadly construed as any bore, hole, passage or other structure, including blind holes, single ended holes or bores, whether threaded or not, that receive part or all of a connector.

In the various embodiments herein, the alternative configurations of a connector retainer mechanism may be incorporated into the configurations shown, for example, in the '193 and '644 patents, or alternatively may be incorporated into other modular flow system designs or into other arrangements that have two components joined together by one or more connectors.

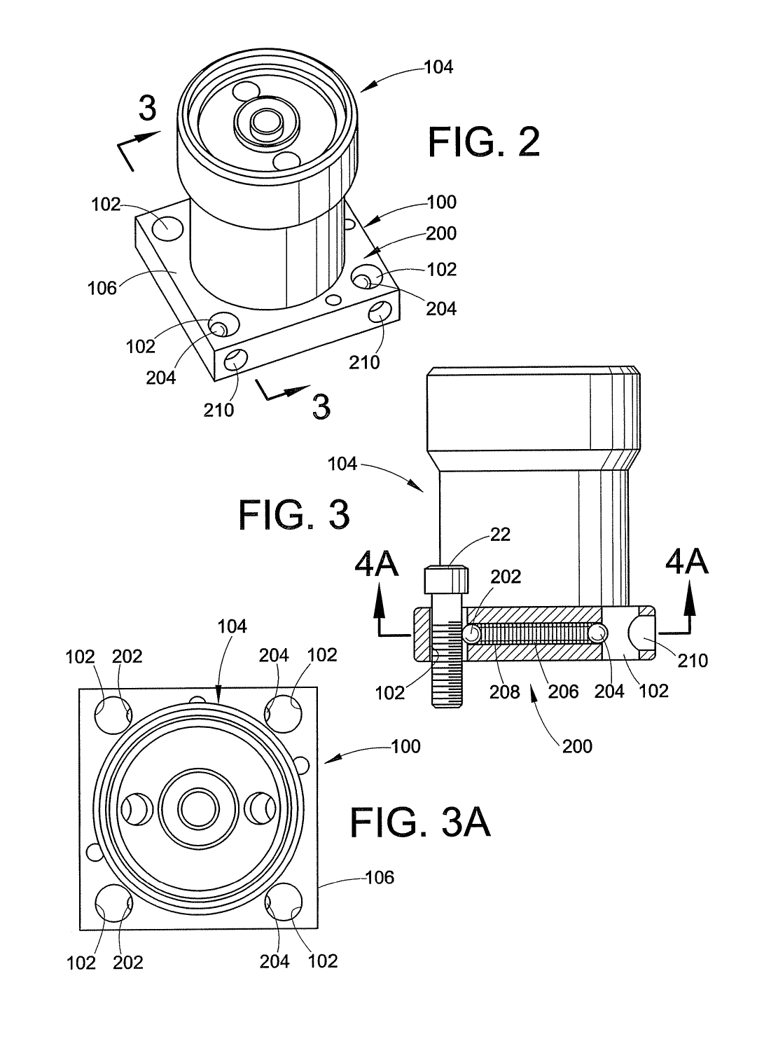

FIG. 2 is a perspective illustration of an exemplary base 100, slightly rotated to reveal an exemplary embodiment of a connector retainer mechanism 200. Since there are four connectors such as threaded bolts 22 (FIG. 1), there are provided two retainer mechanisms 200 because in the exemplary embodiment the retainer mechanism 200 is double ended. However, as will also be described herein, single ended retainer mechanism embodiments are also contemplated. The base 100 thus includes a mounting plate portion 106 having four mounting or through holes 102 each which receives a corresponding connector (for example a threaded connector such as the bolts 22 of FIG. 1). The base may include appropriate structure 104 for installing an active or passive component on the base 100, such as a valve, regulator and so on. The design and configuration of the structure 104 will thus be dependent on the particular type of component being installed into the modular system 10.

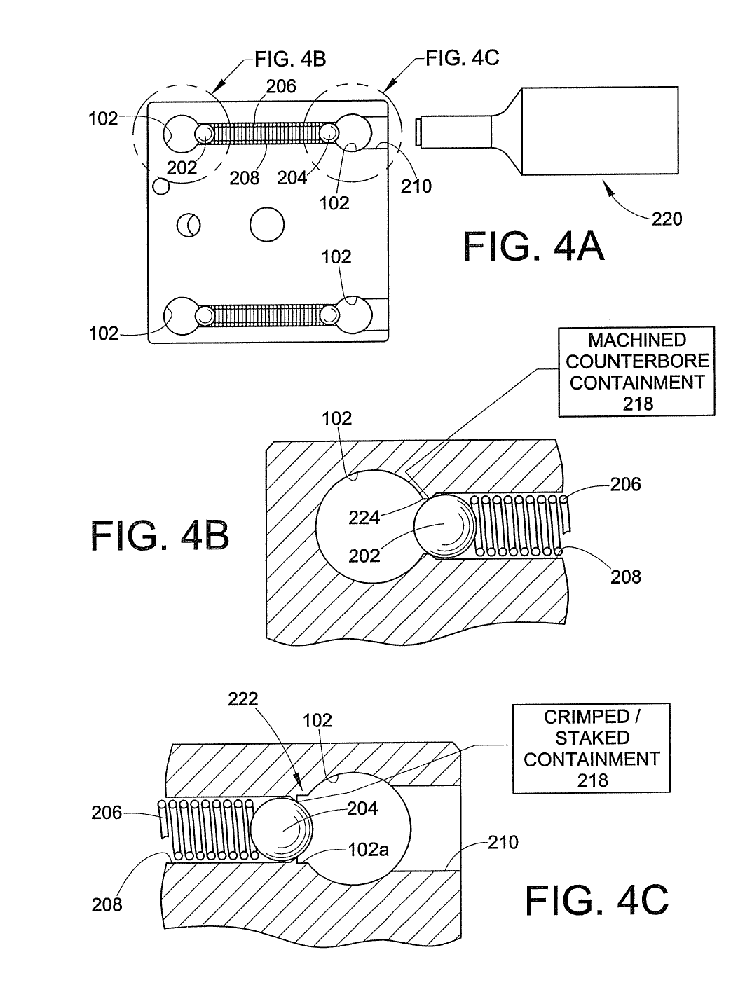

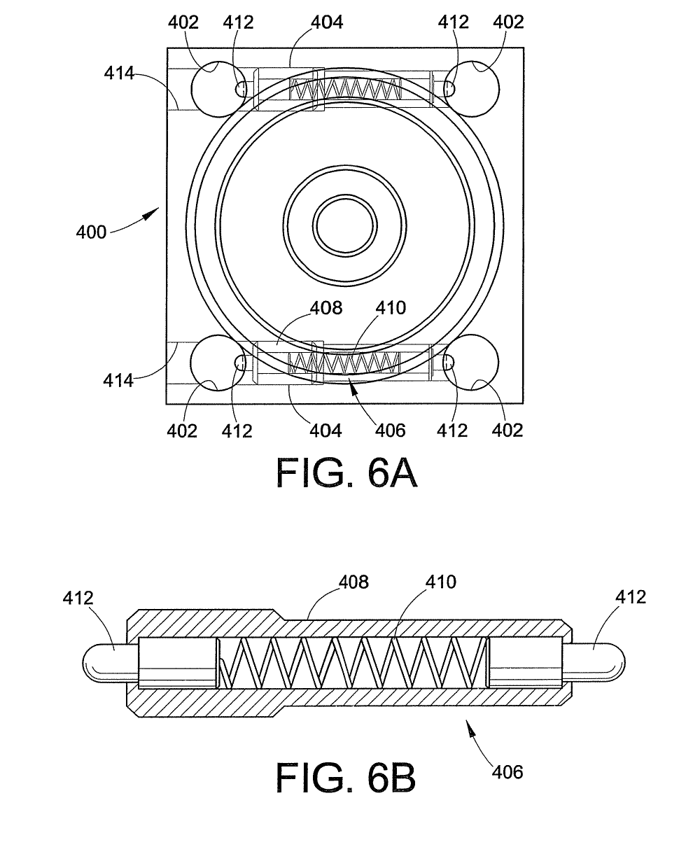

FIG. 3 is a cross-section taken along line 3-3 of FIG. 2, in elevation. This view illustrates the details of the connector retainer mechanism 200. In this embodiment, the retainer mechanism 200 includes a first retainer 202, a second retainer 204, and a biasing element 206. For low cost and ease of assembly, the retainers 202, 204 may be realized in the form of small metal halls, however, other retainer designs, shapes and configurations may be used as needed (see, for example, FIG. 6B illustrating a pin configuration). The retainers do not need to be made of any particular material and moreover do not need to be metal. The biasing element 206 may be realized in the form of a simple spring, but other biasing devices may alternatively he used as appropriate. The retainers 202, 204 and the biasing element 206 are retained in a bore 208 that extends between two of the connector mounting holes 102. In the final installed position, a portion of each retainer 202, 204 extends into its respective mounting hole 102. This feature is readily apparent in FIG. 3A which is a plan illustration of the top side of the base 100. The retainer portion that extends into its mounting hole 102 will interfere with the threads of the connector and thus hold the connector in the mounting hole of the base 100. This is illustrated in FIG. 3 in a somewhat simplified manner with one of the bolts 22 shown as installed. In this example, the bolt 22 may be threaded so that the ball 202 interferes with or engages with one or more thread sections on the bolt 22 to retain the bolt 22 in the mounting hole 102. The biasing element 206 helps push the ball 202 against the shank of the bolt 22 so that this engagement may help retain the bolt 22 in the mounting hole 102. When the bolt 22 is initially pushed down into the mounting hole 102, the resilience of the biasing element 206 may be used to permit the ball 202 to momentarily displace away from the shank (for example, by riding over the outer edges of the threads) so that the bolt 22 can be easily slid into the mounting hole 102. In another exemplary embodiment, a detent or slot or groove (not shown) may be used on a non-threaded or threaded shank that the ball 202 slips into when the bolt 22 is inserted into the mounting hole. The biasing element 206 helps to keep the ball 202 in the groove but allows for easy installation and removal of the bolt 22 in the mounting hold 102.

The connector retainer mechanism concept allows, for example, upside down installation in which the connectors will not fall out of the mounting holes 102 prior to final installation and tightening. The biasing element 206 allows the retainers 202, 204 to be displaced slightly inward as each corresponding connector is inserted into its respective mounting hole 102. For non-threaded connector shanks or bodies (not shown), the connectors may be provided with suitable detents or other structure, such as a raised rib, for example, to allow the retainer to retain the connector in the mounting hole 102. The biasing element 206 also permits the easy removal of a connector from the mounting hole for repair, placement, shipping and so on. Thus, in the exemplary embodiment, the connector retainer mechanisms may be, but need not be, used to releasably retain a removable connector after the connector has been installed into the mounting hole.

The bore 208 may be machined via a side or access hole 210 for example. Since the access hole 210 is not exposed to fluid, it can be left open or plugged if needed.

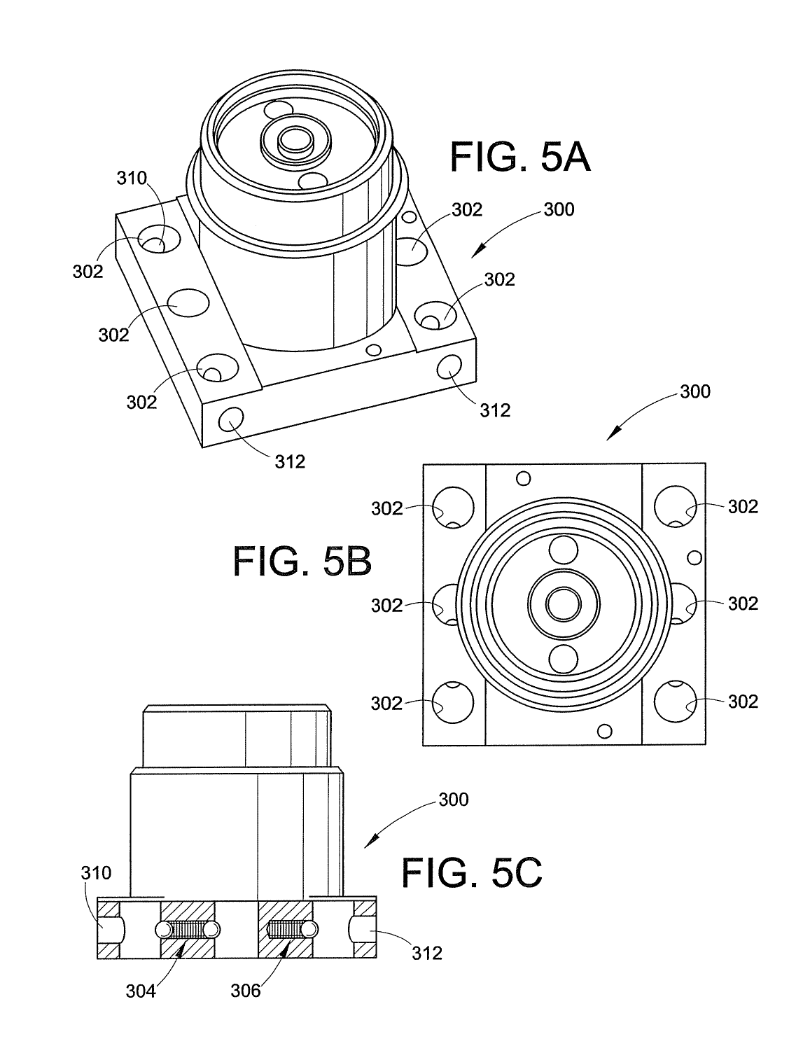

In order to keep the connector retainers 202, 204 within the bore 208, the ends of the bore 208 may be machined or otherwise configured to provide a containment structure 218 so that the connector retainers 202, 204 are not pushed out of the bore 208 by the biasing element 206. FIGS. 4A-4C illustrate two embodiments of suitable containment structures. FIG. 4A is a cross-section in plan taken along the line 4A-4A in FIG. 3, while FIGS. 4B and 4C are enlarged illustrations of portions of FIG. 4A. FIGS. 4A and 4C show that a staking tool or peening operation 220 may be used to produce a containment shoulder 222 by digging up material from a portion 102a of the through hole 102 wall that is proximate the bore 208 end. The staking operation is particularly but not exclusively useful for the end of the bore 208 that is closest to the machining access hole 210. FIG. 4B illustrates another option for a containment structure 218 in the form of a machined counterbore 224 for example. This alternative may be suitable for the end of the bore 208 that is opposite from the machining access hole 210.

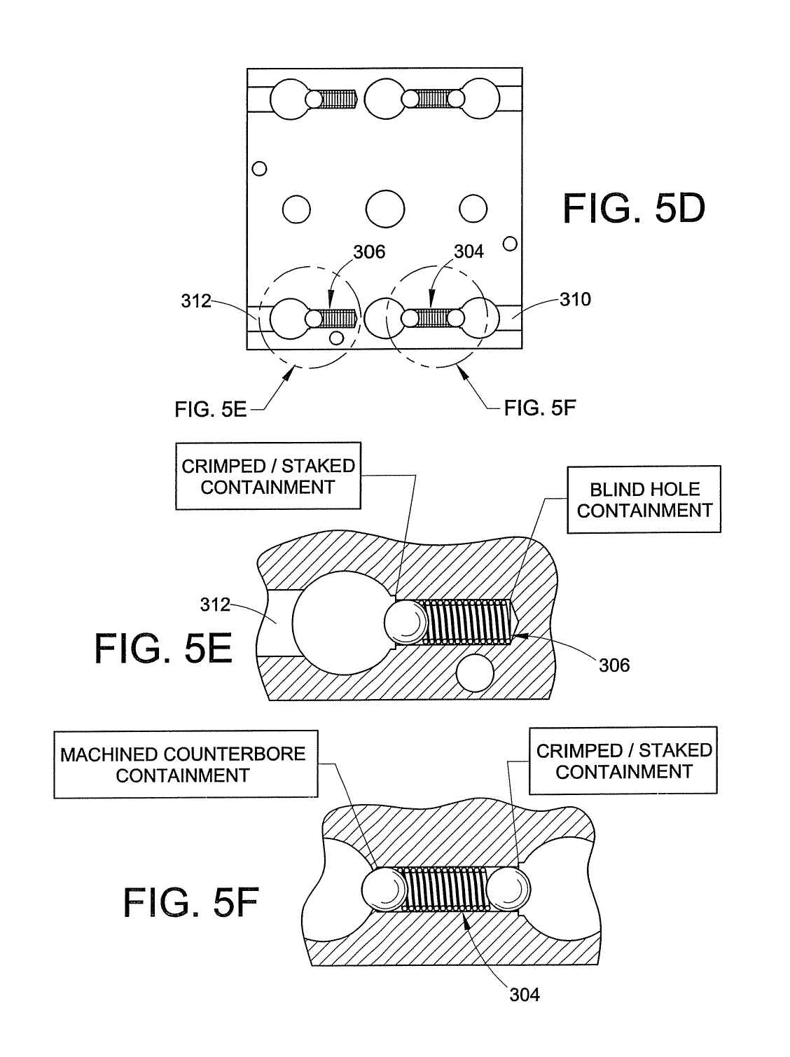

FIGS. 5A-5F are similar in many respects to FIGS. 2, 3, 3A and 4A-4C except for the base 300 being of the type having six mounting holes 302. Because there is an odd number of mounting holes on each side of the base 300, provision is made for a double ended connector retainer mechanism 304 and a single ended connector retainer mechanism 306 (see FIG. 5C). As best illustrated in FIGS. 5D-5F, the double ended mechanism 304 may be formed in a manner similar to that previously described herein with respect to FIGS. 4A-4C. The single ended mechanism 306 may be formed, for example, using the staked containment structure. Note that when a single and double ended retainer mechanism are used, the exemplary embodiment will include two machining access holes 310 and 312.

FIGS. 6A and 6B illustrate another alternative embodiment. FIG. 6A is a transparent plan view of a base 400 having four mounting holes 402. A bore 404 connects respective pairs of the mounting holes 402 and holds a connector retainer mechanism in the form of a cartridge assembly 406. In this example, the cartridge assembly 406 may be a stand alone assembly meaning that the mechanism 406 may be installed into the bore 404 as a single integrated element or unit. In this case, each retainer mechanism or cartridge assembly 406 may be realized in the form of a cartridge body 408 that retains a biasing element 410 and oppositely disposed balls, pins or plunger 412, for example. Upon assembly into the base 400, using for example a screw driver slot or broached Allen hex on the cartridge body, either accessed by pushing the ball/pin back, the pins 412 each project or extend partially into its respective mounting hole 402 and functions to retain a connector such as a threaded bolt. Each cartridge body 408 may be, for example, threadably or otherwise installed into its respective bore 404 via a machining hole 414 that may also be used to machine the bore 404. The cartridge concept may also be realized for a single ended connector retainer mechanism. The cartridge concept may use many different forms of devices in place of the plunger or pin embodiment shown herein.

The inventive aspects have been described with reference to the exemplary embodiments. Modification and alterations will occur to others upon a reading and understanding of this specification. It is intended to include all such modifications and alterations insofar as they come within the scope of the appended claims or the equivalents thereof.

We claim:

1. Apparatus for retaining a connector in a mounting hole of a component, comprising:
a component body having a bore that is generally transverse to the mounting hole; a biasing element disposed in the bore with a retainer, the retainer extending partially into the mounting hole to retain at least a portion of the connector in the mounting hole when the connector is at least partially inserted into the mounting hole.

2. The apparatus of claim 1 wherein the retainer comprises a metal ball, the connector comprises a threaded shank and the biasing element comprises a spring.

3. The apparatus of claim 1 wherein the retainer comprises a cartridge having a pin that extends at least partially into the mounting hole from the bore.

4. The apparatus of claim 3 wherein said cartridge comprises a second pin to form a double ended retainer.

5. The apparatus of claim 4 wherein said cartridge comprises a spring that biases the pin into position in the mounting hole.

6. The apparatus of claim 1 wherein the body comprises first and second mounting holes, and the retainer comprises first and second balls with each ball extending partially into a respective one of said mounting holes.

7. The apparatus of claim 6 wherein the bore extends between said mounting holes.

8. The apparatus of claim 7 wherein each said ball is retained at a juncture between a respective end of the bore and said respective mounting hole.

9. The apparatus of claim 8 wherein one or both of said bore and mounting hole includes structure to retain each ball at least partially in said bore.

10. The apparatus of claim 1 wherein the bore extends to said mounting hole to form an open juncture therewith.

11. The apparatus of claim 10 wherein said ball is retained at said juncture between an end of the bore and the mounting hole.

12. The apparatus of claim 10 wherein one or both of said bore and mounting hole includes structure to retain each ball at least partially in said bore.

13. A surface mount body for a modular flow system, comprising:
a fluid flow device comprising a base having one or more mounting holes therein, a bore that opens at one end to at least one of the mounting holes, and a connector retainer disposed in said bore and partially extending into the mounting hole, said connector retainer being adapted to retain a connector in said mounting hole when the connector is installed therein.

14. The surface mount body of claim 13 wherein said bore extends between two mounting holes, and two connector retainers disposed in said bore, each at a respective end of said bore and each connector retainer partially extending into a respective mounting hole.

15. The surface mount body of claim 13 comprising a containment structure associated with said bore to keep the connector retainer at least partially in said bore even when a connector is not installed in said mounting hole.

16. The surface mount body of claim 15 wherein said containment structure comprises one or both of a counterbore and a staked shoulder.

17. The surface mount body of claim 13 wherein said connector retainer comprises a retainer device and a biasing element.

18. The surface mount body of claim 17 wherein said connector retainer comprises a ball and said biasing element comprises a spring.

19. The surface mount body of claim 13 wherein said connector retainer comprises a retainer cartridge comprising a cartridge body that holds one or more connector retainers and a biasing element as an integrated unit.

20. The surface mount body of claim 13 wherein said fluid flow device comprises a valve.

21. A modular fluid flow system, comprising:
a mounting surface, at least one fluid flow device installable on said mounting surface, said fluid flow device comprising a component having at least one mounting hole therein that receives a connector, said connector joining said fluid flow device to said mounting surface when the system is fully assembled, and a connector retainer associated with said component to releasably retain said connector at least partially in said at least one mounting hole prior to assembly of the system, said connector retainer comprising a portion thereof that extends into the mounting hole.

22. The system of claim 21 wherein said component comprises a bore with said connector retainer at least partially received in said bore.

23. The system of claim 22 wherein said bore opens generally transversely into said mounting hole.

24. The surface mount body of claim 21 comprising a containment structure associated with said bore to keep the connector retainer at least partially in said bore even when a connector is not installed in said mounting hole.

25. The surface mount body of claim 24 wherein said containment structure comprises one or both of a counterbore and a staked shoulder.

26. The surface mount body of claim 21 wherein said connector retainer comprises a retainer device and a biasing element.

27. The surface mount body of claim 26 wherein said connector retainer comprises a ball and said biasing element comprises a spring.
